(19) United States
(12) Patent Application Publication
(10) Pub. No.: US 2006/0047754 A1
(43) Pub. Date: Mar. 2, 2006

(54) Mailbox interface between processors

(75) Inventors: Ramkrishnan Wenkata Subramanian, Bukit Batok East Avenue (SG); Swee Hock Alvin Lim, Hougang Avenue (SG); Gulam Mohamed, Bedok South Avenue (SG)

Correspondence Address: MAGINOT, MOOR & BECK, 111 MONUMENT CIRCLE, SUITE 3000, BANK ONE CENTER/TOWER, INDIANAPOLIS, IN, 46204, US

(73) Assignee: Infineon Technologies AG, 81669 Munchen (DE)

(21) Appl. No.: 10/534,903

(22) PCT Filed: Nov. 15, 2002
(86) PCT No.: PCT/SG02/00270

§ 371 Date: May 16, 2005

(51) Int. Cl. G06F 15/16

(52) U.S. Cl. 709/206

(57) ABSTRACT

A mailbox (5) is proposed for transferring data between two processors (1, 3). The mailbox (5) includes a main memory (7) and an ancillary memory (13, 15). The mailbox stores received data packets in the main memory (7), and stores in the ancillary memory (13, 15) those data packets which are to be read out soonest. In response to a read signal, the mailbox (5) transmits data from the ancillary memory (13, 15) and replenishes the ancillary memory (7) by transferring data to it from the main memory (7). This means that the mailbox (5) can transmit data on the clock cycle following reception of the read signal.

### FIELD OF THE INVENTION

The present invention relates to a mailbox interface between two data processors.

### BACKGROUND OF INVENTION

It is known to transfer data between two processors using a mailbox in which data to be transferred is stored temporarily. FIG. 1 shows a typical such arrangement in which data is transferred between processors 1, 3, which may be respectively a MIPS processor (which is the name of a processor sold by MIPS Technology, Inc) and an OAK DSP (which is the name of a digital signal processor sold by DSP Group Inc.).

The process operates using a mailbox 5 which includes a shared memory 7 and a control unit 9. The mailbox 5 receives messages to be transferred between the two processors and made up of a plurality of data packets. For example, in the case of a message to be sent from the processor 1 to the processor 3, the message is transmitted as a sequence of one or more write instruction data packets (WR) from the processor 1 to the control unit 9, which stores the packets in the shared memory 7. When the message has been fully transmitted to the shared memory 7 an interrupt signal is transmitted to the processor 3, which transmits read command to the control logic 9. In response to the read command the control unit 9 reads stored data packets (RD) from the memory 7, and transmits them to the processor 3. An identical operation is performed in reverse if the processor 3 wants to transmit a message to the processor 1: the processor 3 sends a plurality of write messages (WR) to the control unit 9, then an interrupt signal to the processor 1, which responds by sending read command to the control unit 9, which sends the data in packets (RD) to the processor 1.

Consider this operation in more detail. During the write operation, the control unit 9 receives from the processor 1, in the same clock cycle, a write command, an address signal (indicating the address of processor 1), and the data. The control unit conventionally copies the data to a write register 11 corresponding to the processor 1, from where the data is transferred to the memory 7 on the next clock cycle. Thus, as far as the processor 1 is concerned, the data packet is transferred to the mailbox in a single clock cycle, although the data only reaches the memory 7 after two clock cycles.

By contrast, the read operation cannot be performed as quickly. In a first clock cycle the control unit 9 receives a read signal from the processor 3 (including the read command and the address of the processor 3). Reading the respective packet from the memory 7 generally takes the control unit 9 at least two clock cycles. The first cycle is used to set (“manipulate”) the pointer which determines which location in the memory 7 data is read from, and to set-up the address within the shared memory, and the second cycle is used to latch in the data from the shared memory. Thus the processor 3 only receives the data at least three clock cycles after the read command is transmitted. Furthermore, it is difficult to arrange the pointer manipulation and address set-up to be performed in a single cycle when the reading processor is a MIPS processor which typically operates at a speed of 150 MHz. In the case of the OAK processor it is difficult to meet this timing because the two-phase clock used in the OAK design.

Since there is a delay of several cycles between one of the processors 1, 3 transmitting a read signal and actually receiving the data from the mailbox, the processor receiving the message must employ wait states in which it waits a number of clock cycles for the data to reach it. This slows down the operation of that processor.

### SUMMARY OF THE INVENTION

The present invention aims to provide a new and useful method of operating a data mailbox, and a data processing system which employs the method.

In general terms, the method proposes that the mailbox for temporary storing data packets includes a main memory and an ancillary memory. The mailbox stores received data packets in the main memory, and stores in the ancillary memory those data packets which are to be read out soonest. In response to a read signal, the mailbox transmits data from the ancillary memory, and replenishes the ancillary memory by transferring data to it from the main memory.

The ancillary memory is typically implemented as registers, which means that data can be read out of it immediately (on the next clock cycle), rather than after a delay of one or more clock cycles. Thus, the present invention makes it possible to achieve a read back after zero wait states. Accordingly the data transfer rate is increased between the mailbox and the processor, and the computational power of the processor(s) is not wasted in wait states.

The operation of transmitting data from the ancillary memory may be performed in parallel with (on the same clock cycle as) the replenish operation, so that the ancillary memory does not run out of data irrespective of the number of consecutive read operations.

Conveniently, the ancillary memory may be a FIFO memory.

The main memory of the mailbox may be implemented as in conventional systems, that is such that more than one clock periods are required to extract data from a location in the main memory to which the pointer is not already pointing. The ancillary memory is preferably capable of storing an amount of data which is at least equal to the data to be transmitted during this time. Thus, the ancillary memory is preferably arranged to store at least the number of data packets which are transferred during three clock cycles.

Preferably, a respective ancillary memory is provided for each of the locations (processors) to which the mailbox writes data, each ancillary memory storing the data which is next to be transmitted to that location.

### BRIEF DESCRIPTION OF THE FIGURES

Preferred features of the invention will now be described, for the sake of illustration only, with reference to the following figures in which:

FIG. 1 shows schematically a known memory;

FIG. 2 shows schematically an embodiment of the present invention; and

FIG. 3 shows the process of transferring data from the mailbox a processor in the embodiment of the invention.

### DETAILED DESCRIPTION OF THE EMBODIMENTS

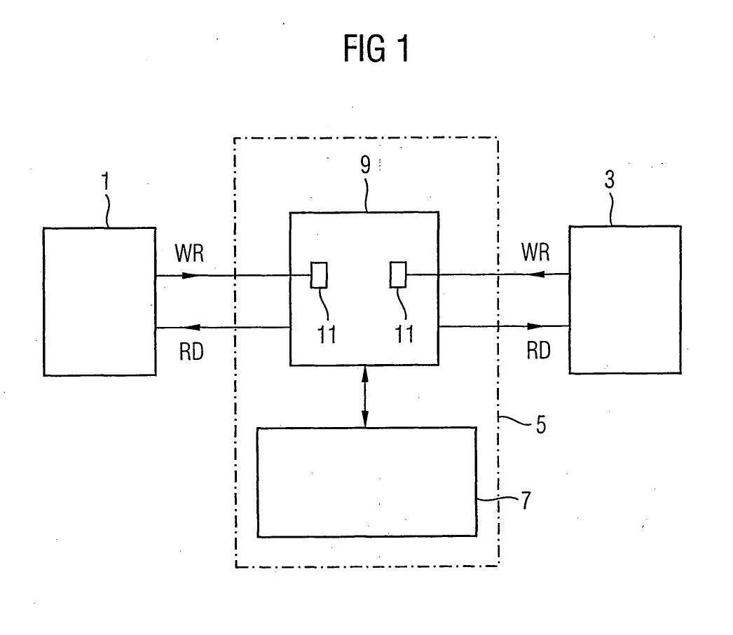

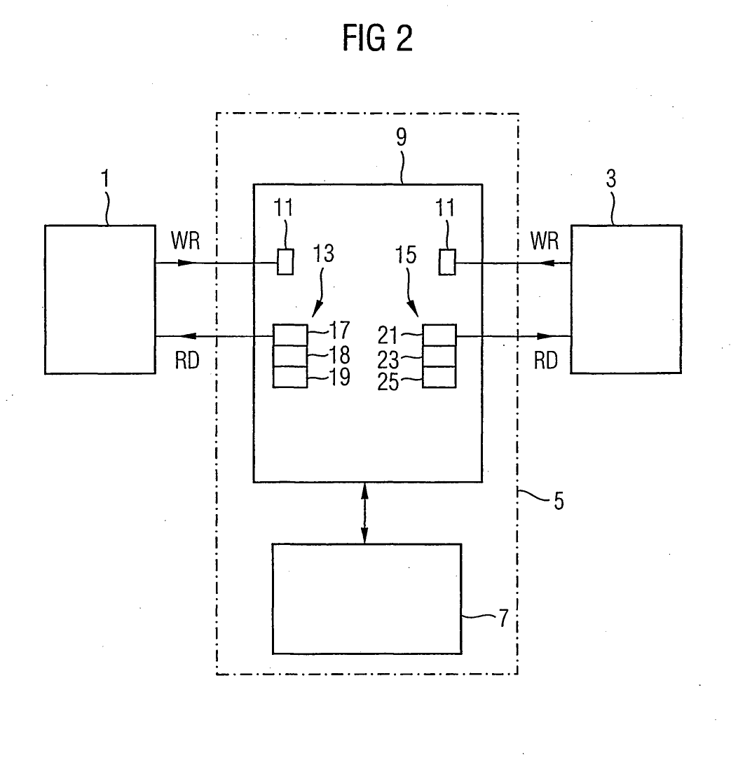

Referring to FIG. 2, data processing system which is an embodiment of the invention is shown. Many elements of FIG. 2 correspond to those of FIG. 1 and are given the same reference numerals. The implementation of features shared between the embodiment and the conventional system of FIG. 1 may be as in the conventional system.

As shown the embodiment includes a number of processors 1, 3. For simplicity only two processors are shown, but the invention is not limited in this respect.

The mailbox 9 of the embodiment includes, in addition to the main memory 7, two ancillary memories 13, 15 located within the control unit. The ancillary memory 13 is a FIFO memory made up of three registers 17, 18, 19, and is used for transmitting data from the main memory 7 to the processor 1 as described below. The ancillary memory 15 is equivalent in construction to the ancillary memory 13. Specifically, the ancillary memory 15 is a FIFO memory made up of three registers 21, 23, 25, and is used for transmitting data from the main memory 7 to the processor 3 as described below.

Consider the operation of transferring a message including a plurality of data packets from the processor 1 to the processor 3. The data packets are received from the processor 1 by the control unit 9 on successive data cycles and written to the write register 11. The write register transfers the data packets to the memory 7 in the manner described above in relation to the known device. The control unit 9 then reads back from the memory 7 in order the first three data packets which are to be transmitted to the processor 3, and writes them in order to the memory 15. Since the memory 15 is a FIFO memory, this means that the first data packet is stored in register 21, the second data packet is stored in the register 23 and the third data packet is stored in the register 25.

Note that in an alternative embodiment, the write register may write the first three data packets of the message in order directly to the ancillary memory and write the rest of the data packets in the message into the memory 7.

In either case, a pointer is maintained pointing to the address in the memory 7 of the fourth packet in the message.

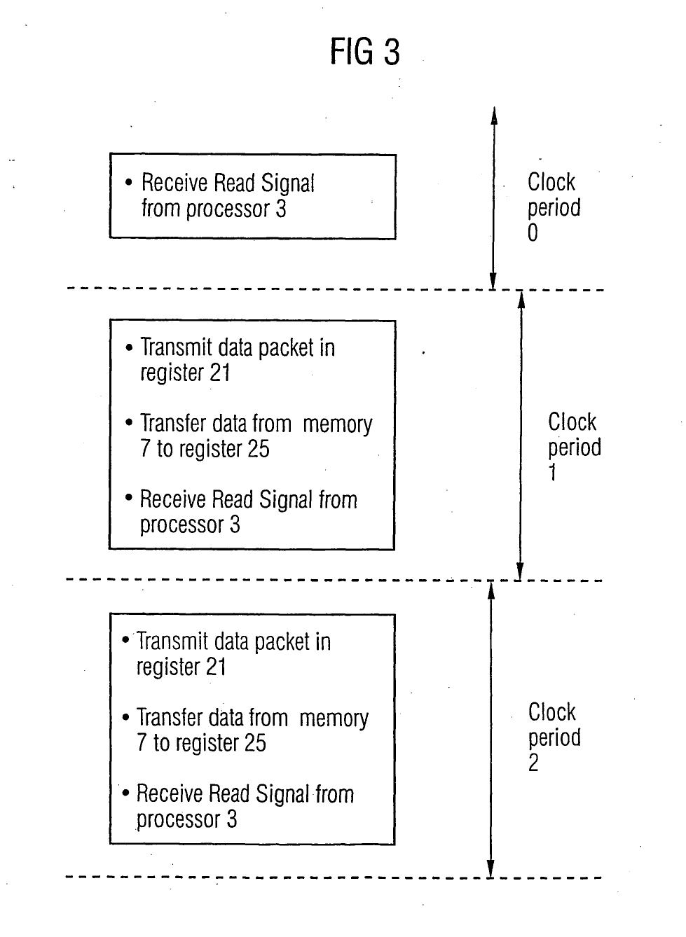

The sequence of operations in which data is sent to the processor 3 is shown in FIG. 3, where time is shown advancing from the top of the diagram to the bottom, and the clock signals are shown as dashed lines.

In a first clock period (clock period “0”), the processor 3 transmits a read signal to control unit 9, in response to the interrupt signal from the processor 1.

In the next clock period (clock period “1”), the control unit 9 transmits the output of the ancillary memory 15 (i.e. the data in the register 21) to the processor 3. The data in the register 23 is thus transferred to the register 21, and the data in the register 25 is transferred to the register 23. In the same clock cycle, the control unit 9 uses the pointer to extract from the memory 7 the fourth data packet which is to be transmitted to the processor 3. The control unit 9 writes this fourth data packet to the ancillary memory 15, so that it is written to the register 25.

Furthermore, during clock period “1”, the processor sends a read signal to the mailbox.

In response to the read signal transmitted in clock period “1”, in the next clock period (clock period “2”) the control unit transmits the new output of the ancillary memory 15 to the processor 3. The data in the register 23 is transferred to the register 21, and the data in the register 25 is transferred to the register 23. The control unit 9 again replenishes the register 25 by extracting the fifth data packet which is to be transmitted to the processor 3, and writes it to the ancillary memory 15, so that it is written to the register 25.

This process continues until all data packets have been transferred to the processor 3.

The operation of sending data packets from the processor 3 to the processor 1 is exactly as described above, but with the ancillary memory 13 used in place of the ancillary memory 15.

Typically, the mailbox 5 is implemented as a single integrated circuit device. The device can be located within a data processing system which further includes the processors 1, 3, and the data is transferred between the mailbox 5 and the processors 1, 3 using a bus of the data processing system according to conventional methods.

Although only a single embodiment of the invention has been described, the invention is not limited in this respect and many variations are possible within the scope of the invention as will be clear to a skilled reader.

For example, it is possible to adapt the mailbox for use in an arrangement with more than two processors. In such a case, a FIFO ancillary memory is preferably provided for each of the processors, to store the first few data packets of any messages which are sent to that processor.

Note that if multiple messages are sent to a given processor, the corresponding ancillary memory stores the first few data packets of the first of these messages which the ancillary memory receives. When all the packets of this message have been successively written to the FIFO ancillary memory (i.e. as earlier packets of the message are successively read by the processor to which the message is directed), further read instructions from the processor cause the FIFO ancillary memory to be replenished successively using respective data packets of the second message.

1-8. (canceled)

9. A mailbox apparatus for temporally storing messages, each message including a sequence of one or more data packets being transferred between a plurality of locations, the mailbox apparatus including a main memory, an ancillary memory, and a control unit which is arranged to:
receive a first message from one of the locations,
store at least a first data packet of the first message in the ancillary memory and at least one other data packet of the first message in the main memory, and
in response to a read signal, transmit a stored data packet from the ancillary memory to another location, and replenish the ancillary memory by transferring at least one other stored data packet to the ancillary memory from the main memory.

10. The mailbox apparatus according to claim 9 wherein the ancillary memory is a FIFO memory.

11. The mailbox apparatus according to claim 9 wherein the ancillary memory is implemented as registers.

12. The mailbox apparatus according to claim 9 wherein the control unit is further configured to transmit the stored data packet from the ancillary memory and replenish the ancillary memory on the same clock cycle.

13. The mailbox apparatus according to claim 9 wherein the ancillary memory is configured to store a number of data packets which is at least equal to a number of clock periods required to extract any data packet from the main memory.

14. The mailbox apparatus according to claim 9, further comprising a plurality of ancillary memories, each ancillary memory having a distinct corresponding location, each ancillary memory being arranged to store data packets to be transmitted to the corresponding location.

15. The mailbox apparatus according to claim 9, wherein the stored data packet comprises the first data packet and the at least one other stored data packet comprises a portion of the first message.

16. A data processing system comprising:
a plurality of processors and a mailbox apparatus, a first processor of the plurality of processors being arranged to transfer a message to a second processor of the plurality of processors by transmitting the message as a series of data packets to the mailbox apparatus and sending a signal to the second processor to indicate the presence of the message in the mailbox apparatus, the second processor being arranged in response to send a read signal to the mailbox apparatus,
the mail box apparatus comprising a main memory, an ancillary memory, and a control unit which is arranged to
receive the message from the first processor,
store at least a first data packet of the message in the ancillary memory and at least one other data packet of the message in the main memory, and
in response to the read signal, transmit the first data packet from the ancillary memory to another location, and replenish the ancillary memory by transferring a stored data packet of the message to the ancillary memory from the main memory.

17. The data processing system according to claim 16 wherein the ancillary memory is a FIFO memory.

18. The data processing system according to claim 16 wherein the ancillary memory is implemented as registers.

19. The data processing system according to claim 16 wherein the control unit is further configured to transmit the first data packet from the ancillary memory and replenish the ancillary memory on the same clock cycle.

20. The data processing system according to claim 16 wherein the ancillary memory is configured to store a number of data packets which is at least equal to a number of clock periods required to extract any data packet from the main memory.

21. A method for temporally storing messages which include a sequence of one or more data packets and which are being transferred between a plurality of locations, the method including:
a) receiving a first message from one of the locations,
b) storing at least a first data packet of the first message in an ancillary memory, and one or more other data packets of the first message in a main memory, and
c) in response to a read signal, transmitting data from the ancillary memory to another location, and replenishing the ancillary memory by transferring other data to the ancillary memory from the main memory.

22. The method of claim 21 wherein step b) further comprises storing the first data packet in a FIFO memory.

23. The method of claim 21 wherein step b) further comprises storing the first data packet in one of a set of registers of the ancillary memory.

24. The method of claim 21 wherein step c) further comprises transmitting data from the ancillary memory to another location and replenishing the ancillary memory in the same clock cycle.

25. The method of claim 21 wherein step c) further comprises transferring the first data packet from the ancillary memory and replenishing the ancillary memory by transferring another data packet of the message from the main memory to the ancillary memory.

26. A method for transferring a message between a first processor and a second processor using an apparatus having a main memory and an ancillary memory, the method including:
a) transmitting the message from the first processor to the apparatus as a sequence of one or more data packets, and sending an interrupt signal to the second processor;
b) storing at least a first data packet of the message in the ancillary memory, and at least one other data packet of the message in the main memory,
c) in response to the interrupt signal, sending a read signal from the second processor to the apparatus,
d) in response to the read signal, transmitting data from the ancillary memory to second processor, and replenishing the ancillary memory by transferring other data to the ancillary memory from the main memory.

27. The method of claim 26 wherein step c) further comprises transmitting the first data packet from the ancillary memory to the second processor, and replenishing the ancillary memory by transferring another data packet of the message from the main memory to the ancillary memory.

28. The method of claim 26 wherein step c) further comprises transmitting the first data packet from the ancillary memory to another location and replenishing the ancillary memory in the same clock cycle.
